(19) United States
(12) Patent Application Publication
(10) Pub. No.: US 2020/0065767 A1
(43) Pub. Date: Feb. 27, 2020

(54) SYSTEM AND METHOD FOR TRACKING EXPERIENCE

(71) Applicant: Susan M. Jansen, Greenwood, IN (US)

(72) Inventor: Susan M. Jansen, Greenwood, IN (US)

(21) Appl. No.: 16/546,971

(22) Filed: Aug. 21, 2019

Related U.S. Application Data
(60) Provisional application No. 62/720,703, filed on Aug. 21, 2018.

(51) Int. Cl. G06Q 10/10; G06F 16/22

(52) U.S. Cl. CPC G06Q 10/105; G06F 16/22

(57) ABSTRACT

A method and system for storing, tracking, and visualizing professional experience.

### RELATED APPLICATIONS

This application claims the benefit of U.S. Provisional Application No. 62/720,703 titled “SYSTEM AND METHOD FOR TRACKING EXPERIENCE” to Susan M. Jansen, filed Aug. 21, 2018, the entire disclosures of which is expressly incorporated by reference herein.

### FIELD OF THE INVENTION

The present disclosure relates generally to a method and system for storing and tracking professional experience.

### BACKGROUND AND BRIEF SUMMARY OF THE DISCLOSURE

In certain aspects, an embodiment of the present disclosure provides a method for tracking and storing a worker's professional experience throughout the course of their career.

According to another embodiment, the present disclosure provides a system for tracking and storing a worker's professional experience throughout the course of their career.

According to another aspect of the present disclosure, each skill or knowledge set/task is assigned a unique identification code.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The previously described aspects and of this disclosure will grow to be appreciated at a greater level once references to the following accompanying illustrations are expounded upon.

FIG. 1 is a process for gathering and displaying the experience of a worker based on their knowledge and skills;

FIG. 2 is a system for storing a worker's experience;

FIG. 3 is a scale of a worker's level of experience;

FIG. 4 is an information tag associated with a worker's self-assessment of their level of experience for a particular skill or knowledge set;

FIG. 5 is an example of an expertise/licensure hierarchy;

FIG. 6 is a visual representation of a skills-and-knowledge-set for a particular job position;

FIG. 7 is a visual presentation of an expertise profile for a recent college graduate;

FIG. 8 is view similar to FIG. 7 showing an expertise profile for the graduate one month after orientation at a particular job;

FIG. 9 is a view similar to FIG. 8 showing an expertise profile one year after graduation;

FIG. 10 is a view similar to FIG. 9 showing an expertise profile three years after graduation;

FIG. 11 is a view similar to FIG. 7 showing an expertise profile of an ideal job candidate and an expertise profile of a particular candidate illustrating the degree of matching between the two profiles;

FIG. 12 is a view showing a leaning proficiency scale;

FIG. 13 is an alternative embodiment visual presentation of an experience profile;

FIG. 14 is a view showing increased shading of a credential as experience levels are verified;

FIG. 15 is a view showing a bubble providing details of a credential;

FIGS. 16 and 17 are views showing alternative embodiment experience profiles for two different professionals with boxes with number showing a professional's self-assessment of credentials and boxes with no numbers indicating that the self-assessment has been verified by a qualified professional;

FIG. 18 is a view showing a professional's total credential score for several categories of credentials, benchmarks for the several categories, the professional's attainment percentage, and totals, and

FIG. 19 is a view of a professional's portable credential profile.

For the purposes of promoting and understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION

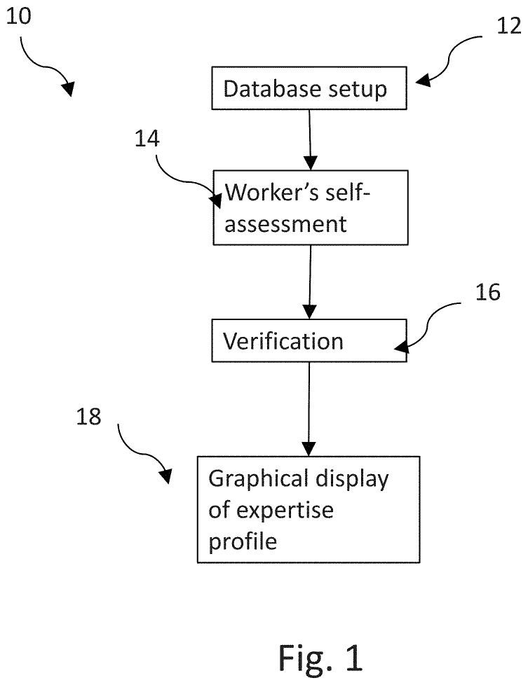

Referring now to FIG. 1, a schematic of a method 10 for tracking and storing a worker's experience is shown. The worker's experience may include knowledge or skills the worker possess along with the level of their expertise. The method includes a computer program for tracking a worker's professional experience and transmitting the data to a data database from which other computers may download the data.

Initially in a configuration step 12, a database 26 is setup to store identifying information for each worker and matrix of specific experiences for a given profession, such as nursing. Next during a self-assessment step 14, a worker performs a self-assessment of their experience level at performing various tasks in their profession. For example, a nurse may be asked to assess their experience level at inserting a #16 Foley catheter in a female patient. Next during a verification step 16, another worker with equal or greater experience at the task may assess the worker's self-assessment. This worker may be referred to as a verifier. A verifier may be required to have an equal or licensure than the worker providing the self-assessment. As a worker inputs self-assessments, a graphic display of their experience is generated at step 18 as discussed below in greater detail.

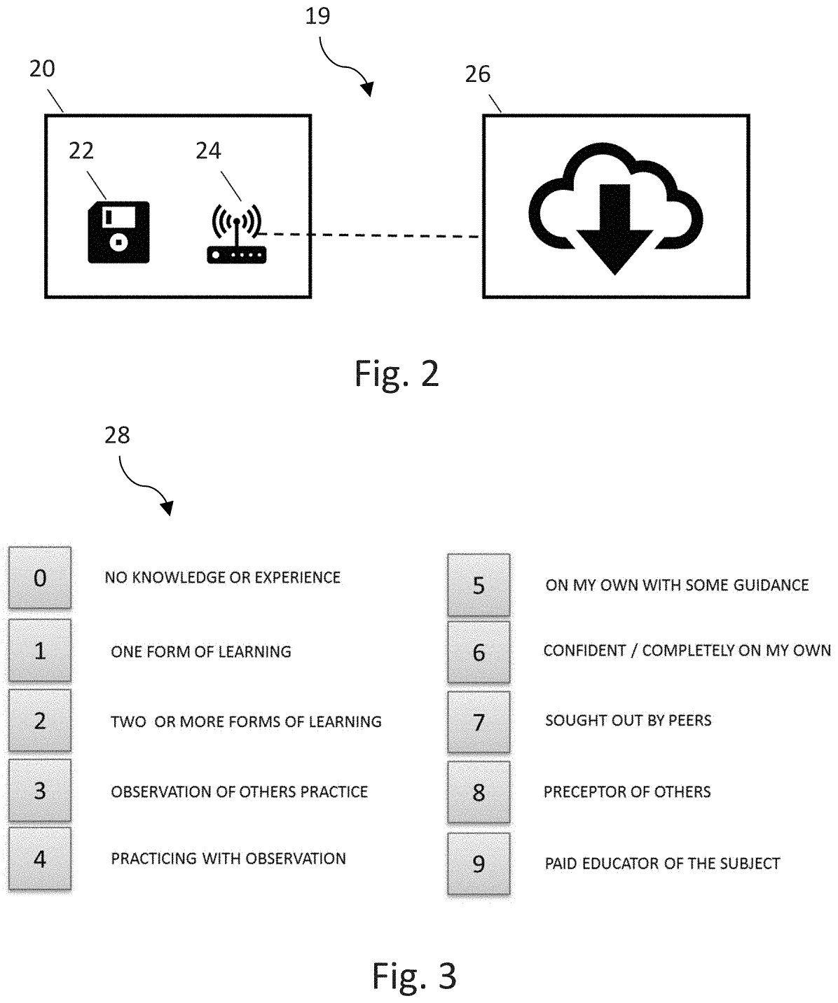

Referring now to FIG. 2, a system 19 for storing a worker's professional experience is shown. In one embodiment, the present disclosure includes a computer 20, a computer program 22, a transceiver 24, and a database 26. A worker may use computer program 22 to record a worker's professional experience information via the method described herein.

The recorded professional experience information may then be transmitted via a transceiver 24 or other communication path to a data database 26. Transceiver 24 is configured to transmit or receive data from data database 26. Transceiver 24 may be a Bluetooth module, a wireless network adapter, a radio-frequency signal processor, an Ethernet connection, or any device known in the art capable of transmitting electronic data. The transmission may occur via a wireless internet connection, a Bluetooth connection, a wired internet connection, or any other means of transmitting electronic data as is known in the art. Data database 26 may be a physical server or a cloud storage device or any other means of storing electronic data as is known in the art. The method and storage system further permits the assessment, documentation, and utilization of professional knowledge and skills by some third party.

As mentioned above, database 26 includes a plurality of tasks for a given profession. For example, database 26 may have various tasks associated with the performance of the job of perioperative nurse. For illustrative purposes, an example of a perioperative nurse's position of employment will be used. However, the present disclosure may be used for any health or other related position. For example, it could be used to track an engineer's skill sets. Each task is given an identification number or code. An employer, such as a hospital, creates a job profile by identifying which tasks are desirable or necessary for a perioperative nurse. Similar profiles are generated for other jobs, such as an ER nurse, postoperative nurse, pediatric nurse, etc.

During self-assessment step 14, a worker accesses a job profile and completes a self-assessment for each task included in the job profile. The assessment may be made based on an experience scale 28, such as that shown in FIG. 3. Scale 28 may be embedded in computer program 22. Scale 28 permits individuals to select a skill or knowledge set and assess themselves on scale 28 for each task in the respective job profile. Once selected, the individual's self-assessment for each task of the unit is saved in database 26 along with the date, time, and location of the self-assessment.

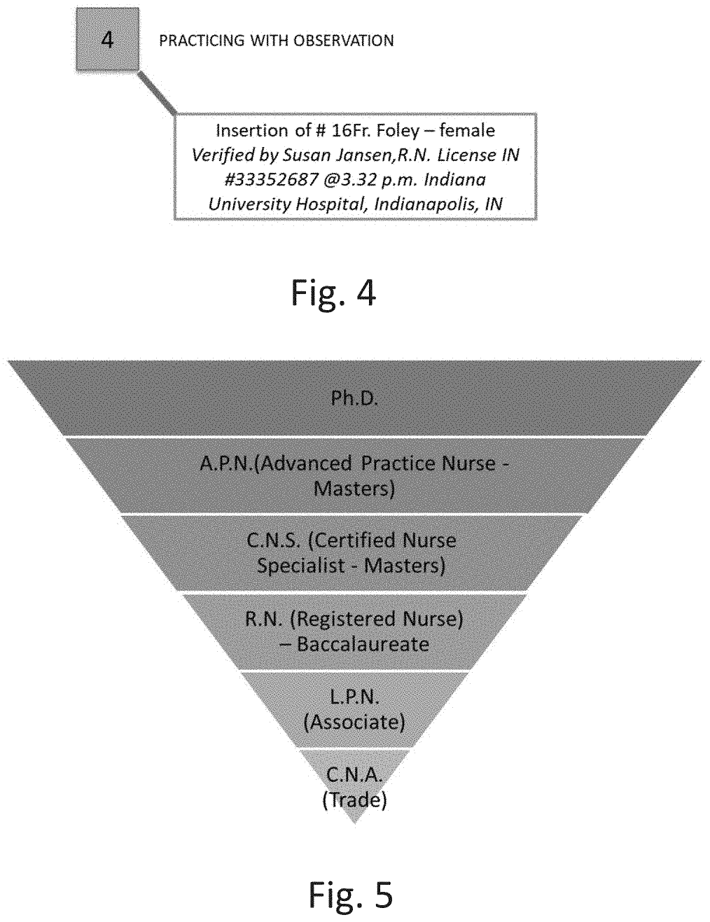

Upon entry of one or more task self-assessments, a person of equal or superior skill may verify the worker's self-assessment. For example, if a perioperative nurse has indicated that they are a “4” (practicing with observation) for inserting a Foley catheter, they may demonstrate the performance of this task to someone of the same or higher licensure known as a verifier. If they satisfy the selected experience level to the verifier, the verifier indicates that the worker satisfies the requirements for performing at this selected level and the verifier's identification, the time of the verification, and the location of the verification are recorded in database 26 as shown in FIG. 4. Referring now to FIG. 5, an example expertise/licensure hierarchy is provided.

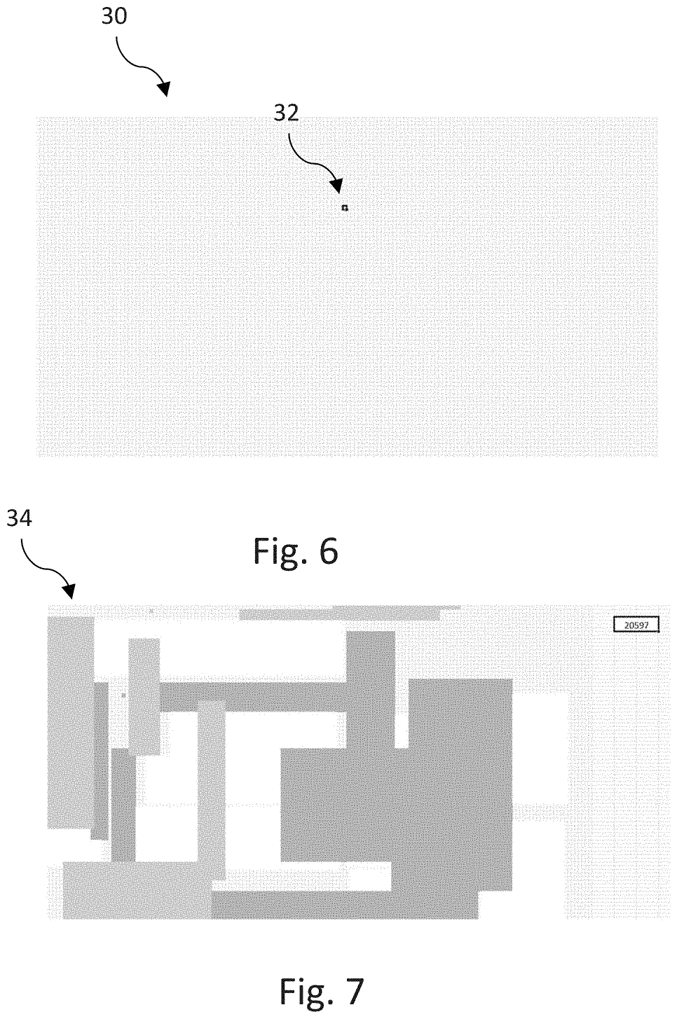

A graphical representation for each job profile 30 may be created showing the various tasks associated with each job profile. As shown in FIG. 6, a grid of tasks/credentials is depicted with a single task/credential 32 highlighted indicating that a self-assessment for that task has been performed.

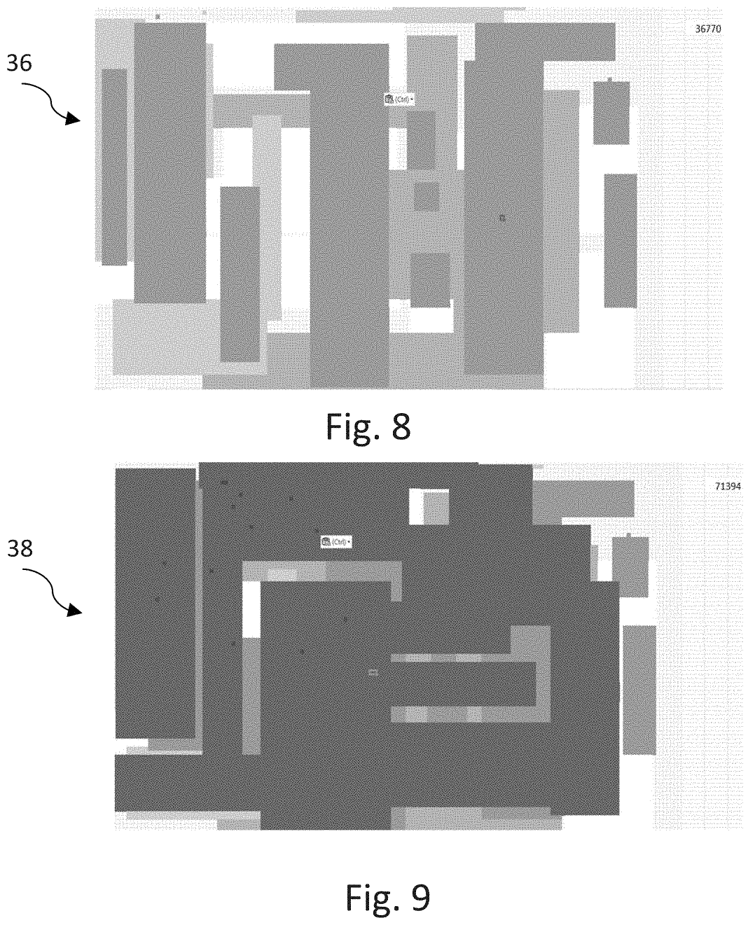

As self-assessments are completed, additional tasks are highlighted. For example as shown in FIG. 7, a recent college graduate has completed multiple task self-assessments as indicated by an expertise profile 34. Variations in shade indicate different levels of expertise. Darker shades indicate more expertise and lighter shades indicate less expertise. As a worker gains experience, they update their self-assessments and receive verification of those assessments as discussed above. FIG. 8 illustrates the recent college graduate's self-assessment and verification expertise profile/graph 36 after working for a month after orientation. Additional highlight blocks or tasks indicate additional skills and knowledge gained by the worker. Additional darker shaded tasks indicate more experience gained by the worker. According to one embodiment, updates to the task highlighting occur once a self-assessment is completed. According to alternative embodiments, updates to task highlights occur once a self-assessment is verified.

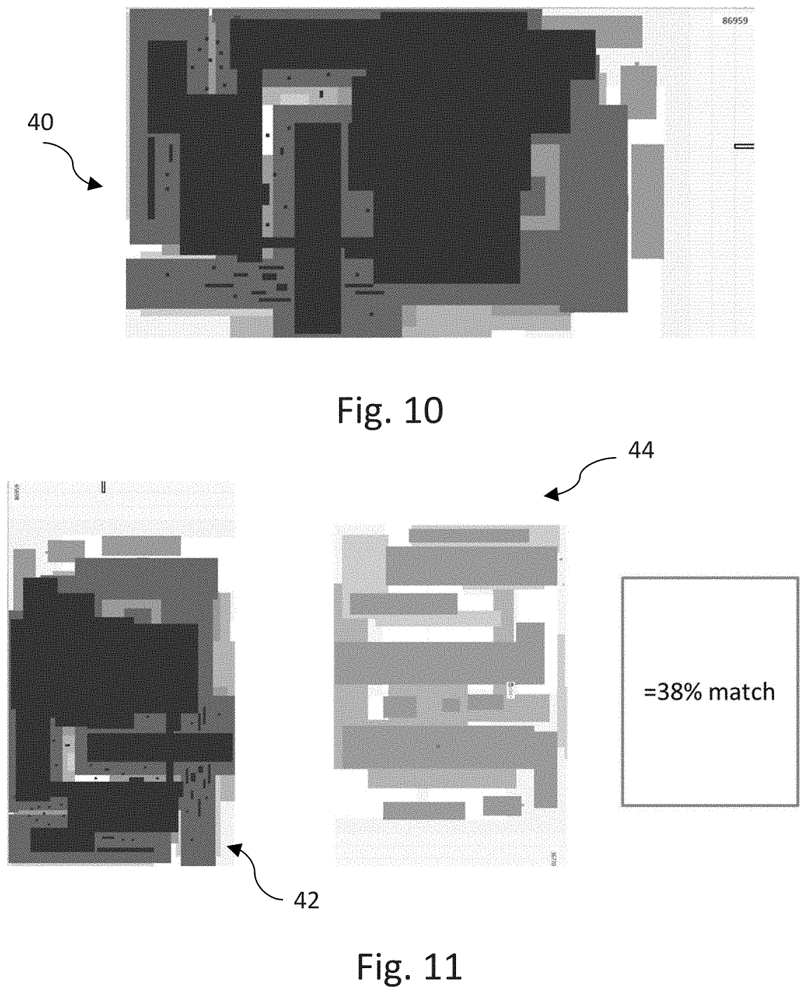

FIG. 9 illustrates what the worker's expertise profile 38 may look like after a year and FIG. 10 illustrates what the worker's expertise profile 40 may look like after three years with ever increasing numbers of highlighted task and ever darker highlighting of task, demonstrating the worker's every increase knowledge and skills.

During hiring, an employer, such as hospital, may compare a candidate's expertise profile with that of an ideal employee for a particular position. As shown in FIG. 11, an ideal candidate expertise profile 42 is shown in the left and a particular candidate's expertise profile 44 is shown in the middle. By visually comparing the two profiles, a hiring manager can quickly determine which candidates are the best match for a particular position. The software may also provide an indication of the percentage match between the ideal candidate and the particular candidate. For example, as shown in FIG. 11, this particular candidate is a 38% match.

When making a new hire for a job position, the hiring manager/HR can review the expertise profile of workers having expertise profiles in database 26. Based on comparisons between ideal candidate expertise profile 42 and the workers' profiles (ex. 44), the hiring manager/HR can identify which internal candidates may be suitable for hiring into the position. The hiring manager can then proactively purse internal candidates based on suitable expertise profiles.

The hiring manager/HR can also assess which tasks for a particular candidate will need additional knowledge or skills. Some task may require a certain level of skill and/or knowledge. Others may not be required, but preferable for the particular candidate to possess.

The failure (or success) of a particular candidate to possess a required skill/knowledge may be highlighted. For example, a candidate's failure to possess a critical (i.e, must have) skill and/or knowledge in a particular task may be highlighted. A candidate, for example an external candidate that does not have an expertise profile could complete a self-assessment to be considered for the position as part of the hiring process.

As indicated above, a worker's expertise profile 44 can be used to determine if the worker is a suitable match for a particular job position. According to the present disclosure, a worker's expertise profile 44 is portable so the worker can use their expertise profile when applying for a job outside of the current employer. A worker would have access to the necessary information.

As illustrated, a worker may generate and store his/her professional experience data within the computer program. It is considered that before the transmission of the professional experience data to the data database occurs, a professional of greater licensure/expertise may validate the self-assessment, though this step is not required. After the professional experience data has been stored in the computer program, the professional experience data may be uploaded to a data database. After the professional experience data has been recorded in the data database, additional workers may download the professional experience data.

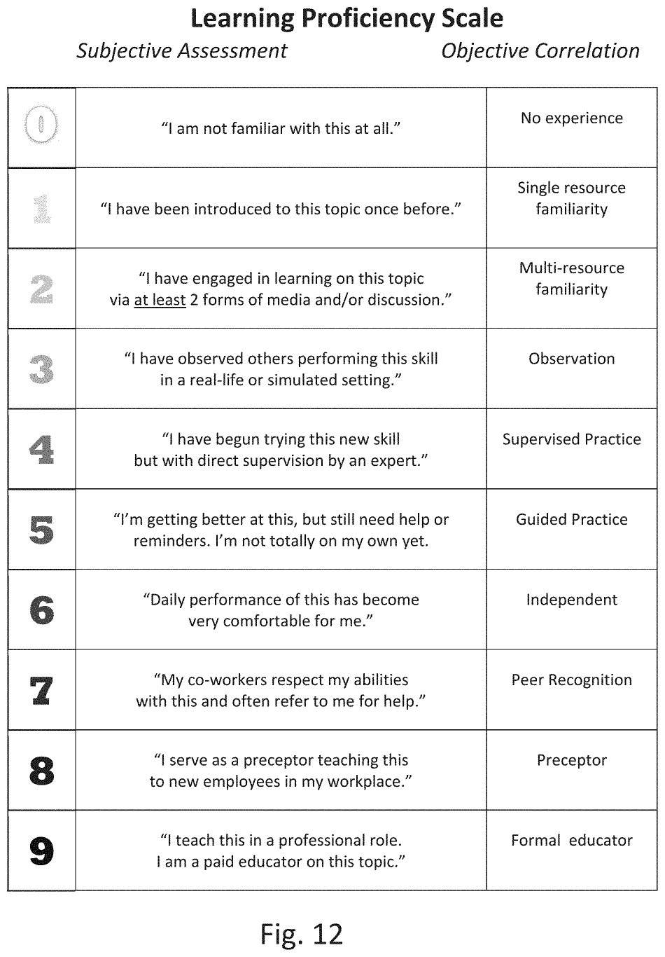

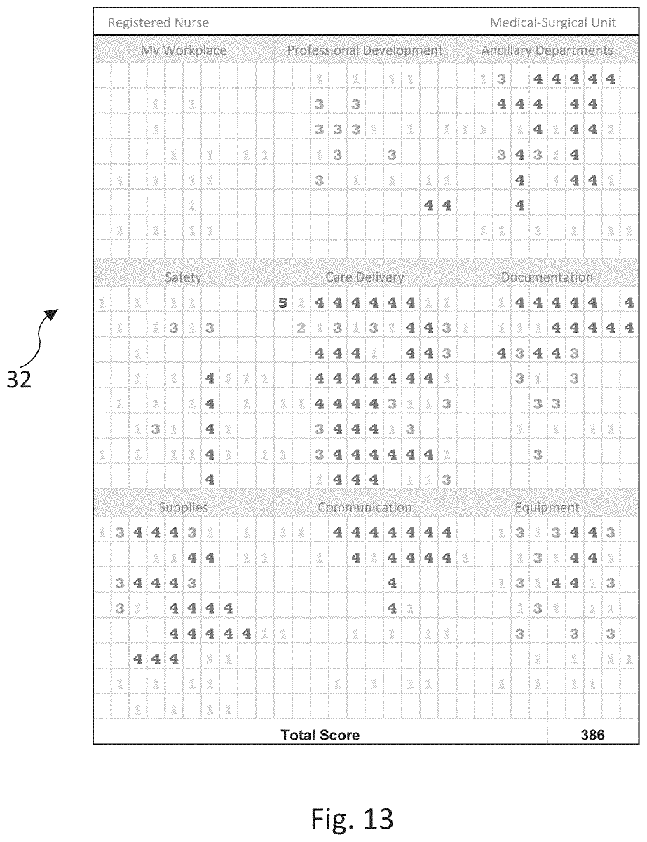

According to one embodiment, different levels of self-assessed experiences are indicated numerically for each task 32. For example as shown in FIG. 12, someone with no experience might have a zero displayed in one task/credential 32 indicating they have no experience, a “1” for another task/credential 32 indicating they have been introduced to a topic, and increasing numeric values indicating increased self-assessed experiences for other tasks/credentials. In addition to the numeric values, the shade of the displayed number may get darker as the self-assessed level increase. Although nine levels are shown in FIG. 12 fewer or more levels may be provided. As shown in FIG. 13, a professional has enterer various self-assessments for nine different categories of task/credentials and a total of the self-assessments is provided in the lower right corner. As self-assessments are updated and/or verified, the numeric value displayed in task 32 is updated accordingly. Other values can also be used, such as alpha values.

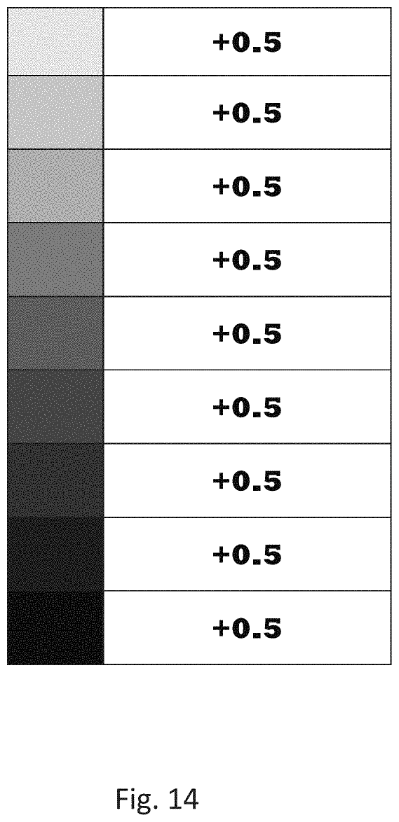

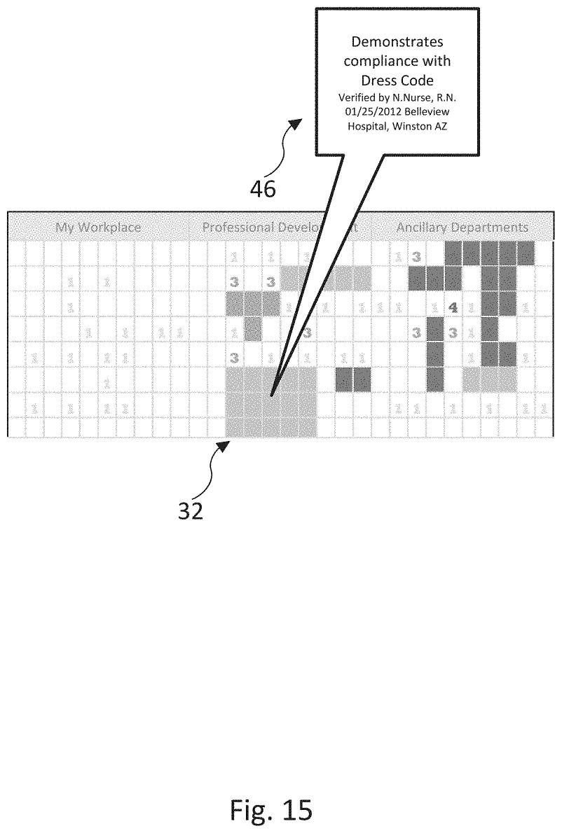

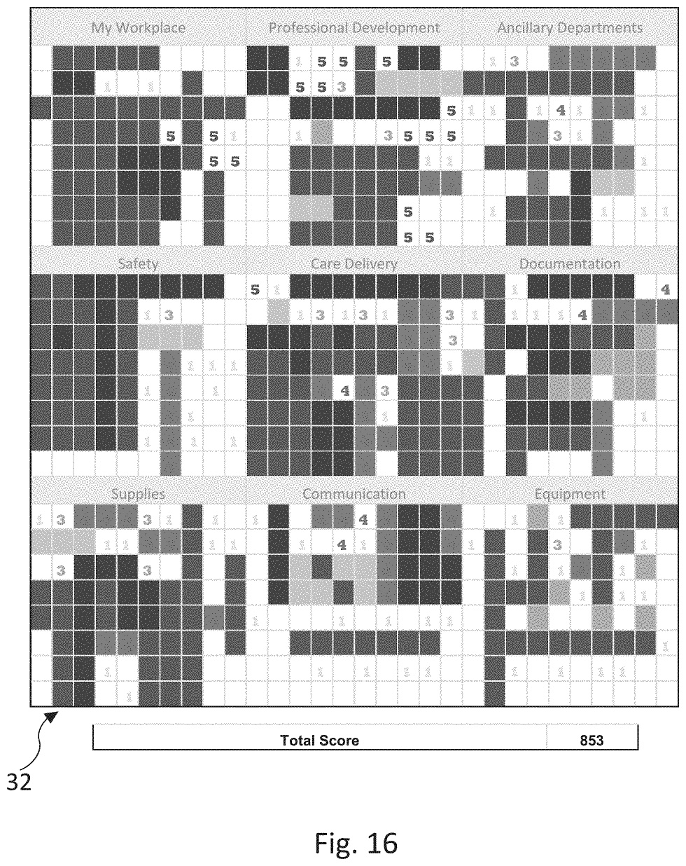

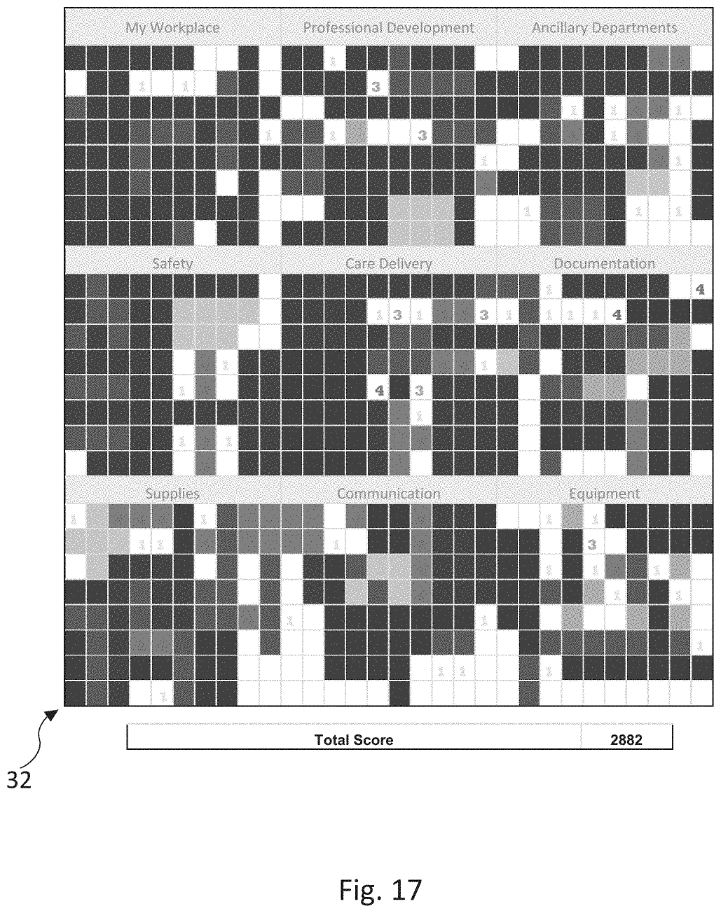

As tasks/credentials are verified by a qualified professional, the point value of each self-assessed task/credential is increased. According to the present embodiment, each verification results in a 0.5 point increase in the task/credential level. For example, a level 1 self-assessment can be increased to 1.5 points. Additionally, visual representation of task/credential 32 may change when a task/credential is verified. For example and as shown in FIGS. 16 and 17, tasks/credentials that are verified are shown as solid squares that do not include a number and unverified task/credentials are shown with numbers. For both solid squares without numbers and squares with numbers, the shade of the respective solid square or number is darkened as the level of experience increases for each task/credential. For example as shown in FIG. 14, the shade for task/credentials increase with each level with the slightest shading being the lowest level (e.g. 1.5 for a verified first level credential) and the darkest shade being the highest level (e.g. 9.5 for a verified ninth level credential). When a skill is verified by qualified personnel, corresponding task/credentials are stamped with time, date, location and verifier name and credentials (e.g. Registered nurse). By hovering over a square 32, the credential and other information is displayed as shown in a bubble 46 in FIG. 15. FIGS. 16 and 17 show two different visual experience displays. For example, FIG. 16 may show one person's visual experience display and FIG. 17 may show another person's visual experience display. Or, FIG. 16 may show one person's visual experience display at a point in time and FIG. 17 may show the same person's visual experience display at another point in time. Because the timing of level increases are recorded, a person's progression can be visualized by providing visual experience displays for different times in sequence. This provides a visualization of a person's progress. Little or no sequential darkening of tasks/credentials over a period of time may indicate little progress. Whereas, faster or significant sequential darkening of tasks/credentials over a period of time may indicate significant progress.

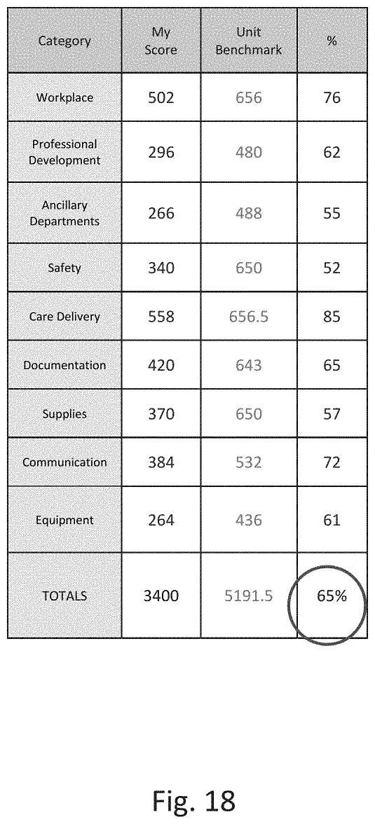

As shown in FIG. 18, a person's credentials may be placed in categories and the total for the credentials in each categories may be added up to determine a total category score. A bench mark for personal in a particular job unit (eg. ER nurse) may be established for the particular job unit. Then, a person's total level score for each category may be compared to the established benchmark to provide an objective indicator of how close a particular person is to completely satisfying the benchmark.

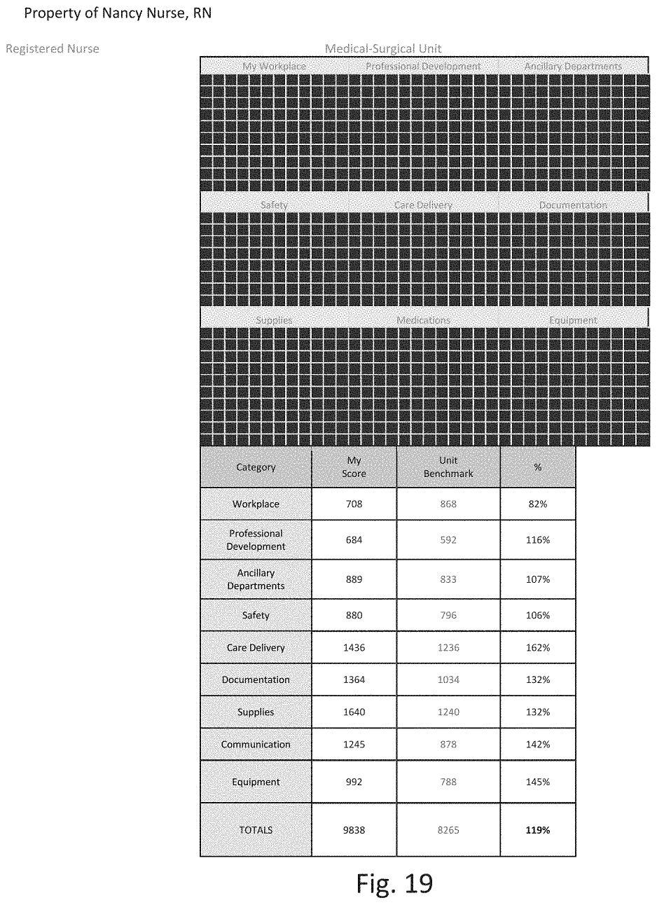

As shown in FIG. 19, an experience profile is displayed graphically with totals for subcategories for rep. The underlying data is personal the professional and provided to the professional to allow the person to transfer between jobs without having to repeat the self-assessment and verification processes described herein.

While this has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

1. A method for tracking and storing professional experience, comprising the steps of:
providing a self-assessment and a skill identification code;
obtaining verification of the self-assessment;
creating a profile;
generating a graphic display of the profile;
transmitting the profile to a database; and
accessing the profile from the database.

2. The method of claim 1, wherein the step of providing the self-assessment further comprises:
quantifying a skill proficiency; and
recording the skill proficiency in the database.

3. The method of claim 2, wherein the step of quantifying a skill proficiency further comprises:
providing a skill proficiency scale; and
evaluating an experience level on the skill proficiency scale.

4. The method of claim 1, further comprising the step of:
providing an interface for self-assessment; and
transmitting the self-assessment to a second database.

5. The method of claim 1, wherein the step of obtaining verification of the self-assessment further comprises attaining verification by a third party.

6. The method of claim 1, wherein the step of creating a profile further comprises generating an array of verified skills.

7. The method of claim 6, further comprising a method for find a candidate, comprising the step of:
providing the array of verified skills and a array of desired skills; and
generating comparability of the array of verified skills and the array of desired skills.

8. The method of claim 1, wherein the step of generating a graphical display of the profile further comprises providing a two-dimensional display of the self-assessment.

9. A method for finding a candidate, comprising the steps of:
providing at least one candidate profile and at least one profile indicative of a desired skill set; and
generating comparability of the at least one candidate profile and the at least one profile indicative of the desired skill set.

10. The method of claim 10, wherein the step of generating comparability includes comparing two corresponding arrays in the at least one candidate profile and in the at least one profile indicative of the desired skill set and generating the comparability by the comparing result.

11. The method of claim 10, wherein the step of generating comparability includes providing a display of the at least one candidate profile overlapping with the at least one profile indicative of the desired skill set.

12. The method of claim 10, wherein the step of generating comparability includes providing a percentage number of the at least one candidate profile overlapping with the at least one profile indicative of the desired skill set.

13. A system for tracking and storing professional experience, said system comprising:
an electronic device;
a database electronically connected to and in communication with the electronic device;
a plurality of skill identification codes provided by the self-assessment program;
a self-assessment program accessible by the electronic device that receives self-assessment levels from a user for a plurality of the skill identification codes; the database storing the self-assessment levels;
a plurality of verified skills based on verification of the self-assessment levels, and
at least one array of verified skills electronically stored within the database.

14. The system of claim 13, further comprising:
a second database for storing the self-assessment levels.

15. The system of claim 13, wherein the electronic device is configured to display a two-dimensional array for graphically depicting the at least one array of verified skills.

16. The system of claim 13, wherein the self-assessment program further including:
a self-evaluating program for allowing a first user to evaluate at least one experience level of a first user; and
a displaying program for producing a graphic display of the experience level of the first user.

17. The system of claim 16, wherein self-assessment program further comprising:
a verifying program for allowing a second user to verify the experience level of the first user during the verifying step.

18. The system of claim 16, wherein the second user has an experience level that is required to have equal to or higher than the experience level of the first user prior to the verifying step.

19. The system of claim 16, wherein the experience level of the first user defines a first expertise profile.

20. The system of claim 19, further comprising:
an expertise comparison program for allowing a user to input a second expertise profile, and
a comparison of the first expertise profile and the second expertise profile.
